(19) United States
(12) Patent Application Publication
(10) Pub. No.: US 2006/0048010 A1
(43) Pub. Date: Mar. 2, 2006

(54) DATA ANALYZING METHOD FOR A FAULT DETECTION AND CLASSIFICATION SYSTEM

(76) Inventors: Hung-En Tai, Taipei Hsien (TW); Haw-Jyue Luo, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 10/711,179

(22) Filed: Aug. 30, 2004

(51) Int. Cl. G06F 11/00

(52) U.S. Cl. 714/37

(57) ABSTRACT

A data analyzing method for a fault detection and classification system. The method includes extracting a set of raw data from a fault detection and classification system, separating the raw data for generating another set of classified data via a predetermined filtering condition, and utilizing a predetermined statistical method for analyzing the classified data.

### BACKGROUND OF INVENTION

1. Field of the Invention

The invention relates to a data analyzing method for a fault detection and classification system of semiconductor equipments, and more particularly, to a data analyzing method for classifying output data of a fault detection and classification system output classification and then performing statistical analysis.

2. Description of the Prior Art

During the manufacturing process of semiconductors where wafers are processed (such as etching or condensation) from semiconductor equipments, foundry companies readily investigate and prevent various factors that may result in damage to the overall yield.

In general, a low yield in semiconductor manufacturing is usually caused by two factors: one being particle defects and the other being unexpected events caused by the manufacturing equipments. As the manufacturing technology in semiconductor industry develops, the area of integrated circuits decreases steadily. Consequently, as the manufacturing margin decreases to a certain point, an unexpected event caused by the semiconductor equipments could result in serious damage to the manufacturing yield. Essentially, semiconductor equipment operators today use a fault detection and classification system to analyze the equipment output data to prevent unexpected events from happening in the future.

As commonly known, semiconductor equipments regularly produce large volumes of mixed data. As a result, a prior art statistical method has been frequently used to analyze and observe data variation by calculating average values at different time. However, it becomes much more difficult to detect the root of the problem, as utilizing the average value for a statistical analysis would easily result in normalization of the maximum or minimum value. On the other hand, if a large volume of data output generated from semiconductor equipments were to be processed by a real-time method, the prior art statistical method mentioned earlier would become inappropriate.

In general, the prior art fault detection and classification system used today mainly utilizes a trend chart to detect unexpected events caused by semiconductor equipments. For example, the x-axis of the trend chart represents the statistical volume (such as the yield) whereas the y-axis stands for date/time. Consequently, operators will be able to monitor the trend and variation of statistical volume by displaying values of the statistical volume sequentially relating to the date/time in a correct order. Nevertheless, when there is a large number of data items waiting to be processed, semiconductor equipment operators will have to spend a significant amount of time observing the changes in statistic volume, thereby resulting in overall equipment management inefficiency.

### SUMMARY OF INVENTION

It is therefore one of the objectives of the claimed invention to provide a data analyzing method for a fault detection and classification system to solve the above-mentioned problem.

According to an embodiment of the claimed invention, the data analyzing method for a fault detection and classification system includes extracting a plurality of raw data from the fault detection and classification system, separating the raw data to generate classified data according to a predetermined filtering condition, and utilizing a predetermined statistical method to analyze the classified data.

The claimed data analyzing method for a fault detection and classification system essentially selects the needed data from the raw data that is extracted from a fault detection and classification system, conducts a statistical analysis, and presents the statistical result in figure format to the semiconductor equipment operators. By locating a specific wafer manufacturing step or data range, the operators are able to investigate unexpected events caused by the manufacturing equipments to ultimately reduce system complexity and cost resulted from large quantity of data comparisons. Consequently, unexpected events will also be monitored regularly as the maximum and minimum values are not likely to be normalized.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a flowchart diagram illustrating a data analyzing method of a fault detection and classification system according to the present invention.

FIG. 2 is a schematic diagram illustrating the data analyzing method according to the present invention generating classified data.

### DETAILED DESCRIPTION

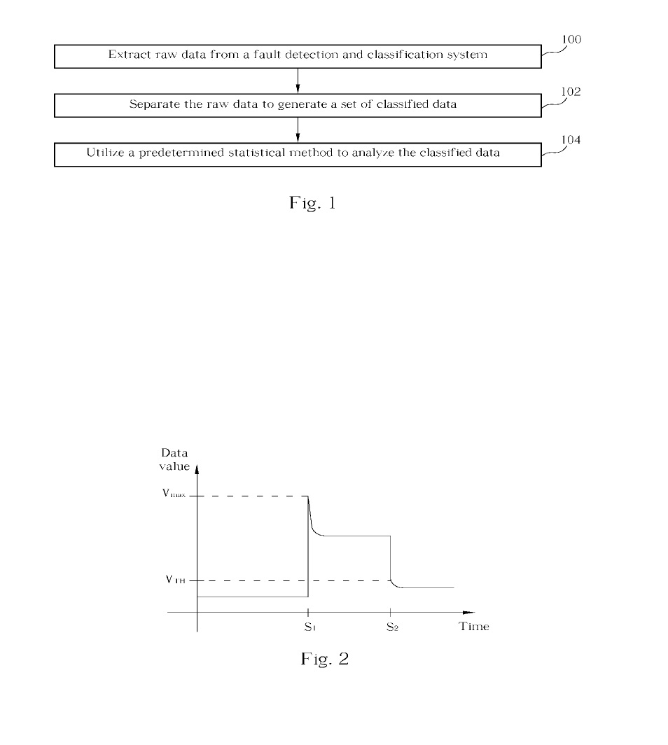

Please refer to FIG. 1. FIG. 1 is a flowchart diagram illustrating a data analyzing method for a fault detection and classification system according to the present invention. A data analysis method generally includes the following steps:

Step 100: Extract raw data from the fault detection and classification system;
Step 102: Separate the raw data to generate classified data according to a predetermined filtering condition; and
Step 104: Utilize a predetermined statistical method to analyze the classified data.

Essentially, the semiconductor equipment operators are able to extract a large chunk of raw data from the fault detection and classification system in real-time (step 100) and then separate the raw data to generate classified data according to a predetermined filtering condition (step 102). An example of this is selecting raw data corresponding to a particular wafer manufacturing step (also referred to as semiconductor manufacturing equipment data). In addition, a threshold value is also used to compare with values of the selected raw data corresponding to the particular wafer manufacturing step to generate classified data.

Lastly, in this preferred embodiment, a predetermined statistical method is adopted to analyze the above classified data (step 104), in which the predetermined method can be shown in the way of a t-test, a one-way variance analysis, a discriminate analysis, or a data mining operation. Essentially, t-tests are able to distinguish the difference between two wafers, one-way variance analyses are able to detect the difference between two manufacturing equipments, discriminate analyses are able to distinguish the difference among fault categories, and data mining operations are able to discover the root cause of each fault.

Please refer to FIG. 2. FIG. 2 is a schematic diagram illustrating the data analyzing method according to the present invention generating classified data, in which the x-axis represents time and the y-axis represents values of raw data. At time S₁, the raw data contains a maximum value Vₘₐₓ. Ideally, equipment operators are able to determine whether an event has taken place by extracting a chunk of data greater than the threshold value V_{TH} after time S₁. In other words, a set of classified data described above is extracted from the raw data between time S₁ and S₂ and then analyzed via the predetermined statistical method mentioned previously. In the end, an analyzed result in table or diagram format will be transmitted to the semiconductor equipment operator at a remote terminal machine.

Therefore, in the preferred embodiment, the maximum value of Vₘₐₓ will not be normalized inappropriately, and the failure of operators being unable to detect equipment events, consequently, is also unlikely to take place. In contrast to the prior art, a data analyzing method for a fault detection and classification system according to the present invention selects a set of usable data from the raw data extracted from a fault detection and classification system, conducts a statistical analysis, and presents the statistical result in figure format to the semiconductor equipment operators. By locating a specific manufacturing step or data range, the operators are able to investigate unexpected events caused by the manufacturing equipments to ultimately reduce system complexity and cost resulted from large quantity of data comparisons.

In addition, the data analyzing method according to the present invention also minimizes the failure possibility of detecting an unexpected event as a result of inappropriate normalization of the maximum or minimum values extracted from equipment data by the formerly stated averaging statistical method. As the former averaging statistical method stated earlier is strongly avoided, the present invention ensures that the real-time data content is well retained and the chance of losing valuable information from inappropriate normalization is greatly reduced. Also, by exacting desirable information from real-time data via an appropriate filtering condition and utilizing an appropriate statistical method to further process these data, the data analyzing method for a fault detection and classification system according to the present invention further enhances the ability to lower the complexity of data analysis and at the same time, reduces a significant amount of labor and time. In other words, this proposed data analyzing method of fault detection and classification system is able to greatly increase the overall management efficiency of semiconductor equipments.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data analyzing method for a fault detection and classification system comprising:
(a) extracting a plurality of raw data from the fault detection and classification system;
(b) separating the raw data for generating classified data according to a predetermined filtering condition; and
(c) utilizing a predetermined statistical method for analyzing the classified data.

2. The data analyzing method of claim 1 wherein the predetermined filtering condition is used for selecting data corresponding to a particular wafer manufacturing step from the raw data.

3. The data analyzing method of claim 2 wherein the predetermined filtering condition corresponds to a threshold value of the particular wafer manufacturing step and step (b) generates the classified data by selecting data matching the threshold value from the raw data.

4. The data analyzing method of claim 1 wherein the predetermined statistical method is a one-way variance analysis, a data mining operation, or a discriminate analysis.
